(19) United States
(12) Patent Application Publication
(10) Pub. No.: US 2007/0126649 A1
(43) Pub. Date: Jun. 7, 2007

(54) Microwave based air purifier

(76) Inventors: Chang Yul Cha, Laramie, WY (US); Beau Braunberger, Laramie, WY (US)

Correspondence Address: John O. Mingle;Attorney for Applicants, P.O. Box 1311, Laramie, WY, 82073, US

(21) Appl. No.: 11/293,355

(22) Filed: Dec. 2, 2005

(51) Int. Cl. H01Q 13/10

(52) U.S. Cl. 343/767; 343/770; 343/771

(57) ABSTRACT

An efficient device for air purification occurring in the presence of activated carbon or its equivalent by decomposing adsorbed impurities, such as volatile organic compounds, on the carbon surface by radiofrequency energy in the microwave range. The device contains an activated carbon bed, or its equivalent, for adsorption of impurities and is regenerated in-place by with radiofrequency energy in the microwave range by usage of one or more slot antennas. An oxygen-free sweep gas removes the impurities. The device is housed in a microwave cavity designed to reflect the microwaves leaving the slot antennas into a center section containing the activated carbon bed.

### BACKGROUND OF INVENTION

1. Field of Invention

The present invention relates to an apparatus using radiofrequency microwave energy from slot waveguide antennas along with carbonaceous material to purify an air stream containing hazardous materials, particularly organic vapors, wherein the carbonaceous material is regenerated without physical removal.

2. Background

Hazardous waste often occurs which contains organic compounds that are easily volatilized under common conditions and often naturally pollute a gas stream, like air. In many instances recovery of said waste is required or such waste may be chemically reacted into a more environmental friendly substance.

Adsorption of organics occurs readily upon carbonaceous materials, such as activated carbon. Thus a contaminated air stream passed through a bed of activated carbon will substantially purify it. Saturation of the bed will eventually occur so removal of the adsorbed organics is performed to allow reuse of the activated carbon. This desorption is conventionally performed by heating the bed to volatilize the organics. For instance, conventionally steam is employed for this task.

The subject invention is designed to efficiently carry out the above described process by utilizing an efficient microwave reflecting chamber fed by microwaves from slot waveguide antennas.

Conveniently microwaves are employed for this desorption since activated carbon is a very good absorber of such microwaves. The desorbed volatiles, which are not necessarily in the same chemical form as they were when adsorption occurred, are then collected by a sweep gas. The subject invention represents an apparatus designed to efficiently perform the above process without removing the activated carbon for regeneration in a separate apparatus.

Quantum radiofrequency (RF) physics is based upon the phenomenon of resonant interaction with matter of electromagnetic radiation in the microwave and RF regions since every atom or molecule can absorb, and thus radiate, electromagnetic waves of various wavelengths. The rotational and vibrational frequencies of the electrons represent the most important frequency range. The electromagnetic frequency spectrum is usually divided into ultrasonic, microwave, and optical regions. The microwave region is from 300 megahertz (MHz) to 300 gigahertz (GHz) and encompasses frequencies used for much communication equipment. For instance, refer to Cook, Microwave Principles and Systems, Prentice-Hall, 1986. For information about waveguide slot antennas refer to Wade, WIGHZ Microwave Antenna Book, available on the Web.

Often the term microwaves or microwave energy is applied to a broad range of radiofrequency energies particularly with respect to the common heating frequencies, 915 MHz and 2450 MHz. The former is often employed in industrial heating applications while the latter is the frequency of the common household microwave oven, and therefore represents a good frequency to excite water molecules. In this writing the term “microwaves” is generally employed to represent “radiofrequency energies selected from the range of about 500 to 5000 MHz”, since in a practical sense this total range is employable for the subject invention.

The absorption of microwaves by the energy bands, particularly the vibrational energy levels, of atoms or molecules results in the thermal activation of the nonplasma material and the excitation of valence electrons. The nonplasma nature of these interactions is important for a separate and distinct form of heating employs plasma formed by arc conditions at a high temperature, often more than 3000° F., and at much reduced pressures or vacuum conditions. For instance, refer to Kirk-Othmer, Encyclopedia of Chemical Technology, 3rd Edition, Supplementary Volume, pages 599-608, Plasma Technology. In microwave technology, as applied in the subject invention, neither condition is present and therefore no plasmas are formed.

Microwaves lower the effective activation energy required for desirable chemical reactions since they can act locally on a microscopic scale by exciting electrons of a group of specific atoms in contrast to normal global heating which raises the bulk temperature. Further this microscopic interaction is favored by polar molecules whose electrons become easily locally excited leading to high chemical activity; however, nonpolar molecules adjacent to such polar molecules are also affected but at a reduced extent. An example is the heating of polar water molecules in a common household microwave oven where the container is of nonpolar material, that is, microwave-passing, and stays relatively cool.

In this sense microwaves are often referred to as a form of catalysis when applied to chemical reaction rates. For instance, refer to Kirk-Othmer, Encyclopedia of Chemical Technology, 3rd Edition, Volume 15, pages 494-517, Microwave Technology.

Related United States microwave patents include:

| No. | Inventor | Year |
|---|---|---|
| 6,207,023 | Cha | 2001 |
| 6,419,799 | Cha | 2002 |

Referring to the above list, patent '023 entitled “Process for Microwave Air Purification” discloses a process, not a device, utilizing an activated carbon bed for air purification, particularly for hazardous materials. When saturated the bed is removed for regeneration into a separate processing section.

Patent '799 entitled “Process for Microwave Gas Purification” utilizes the equipment of patent '023 and therefore does not regenerate the activated carbon bed in-place.

### SUMMARY OF INVENTION

The objectives of the present invention include overcoming the above-mentioned deficiencies in the prior art and providing an economically viable device for the microwave cleanup of impure air. The device contains an activated carbon bed or its equivalent for adsorption of impurities that is regenerated in-place with radiofrequency energy in the microwave range by usage of one or more slot antennas. Additional the device is housed in a microwave cavity designed to reflect the microwaves leaving the slot antennas into a center section containing the activated carbon bed.

### BRIEF DESCRIPTION OF THE DRAWINGS

FIG. 1 shows the microwave based air purifier designed to remove impurities from an air stream with activated carbon that is regenerated without removal.

FIG. 2 shows an cross section of the device in FIG. 1.

### DETAILED DESCRIPTION OF INVENTION

Microwaves are a versatile form of energy that is applicable to enhance chemical reactions since the energy is locally applied by its largely vibrational absorption by nonpolar molecules and does not produce plasma conditions. Particularly reactions that proceed by free-radical mechanisms are often enhanced to higher rates because their initial equilibrium thermodynamics is unfavorable. A second class of enhanced reactions are those whose reaction kinetics appear unfavorable at desirable bulk temperature conditions.

Carbonaceous material is an excellent microwaves absorber since it has a wide range of polar impurities that readily interact with such radiofrequency energy especially in electron vibrational modes. Carbonaceous material for use with the subject invention commonly comprises activated carbon, char, soot, pyrolytic carbon, carbon black, activated charcoal, and metal carbides. In many instances activated carbon is the preferred material to employ under ambient temperature and pressure conditions, although activated charcoal, if readily available, is likely more cost effective. However in gaseous systems, especially at higher temperatures, other carbonaceous materials such as metal carbides, especially silicon carbide, are convenient to utilize. Silicon carbide is conveniently utilized as a microwave absorbing substrate to enhance conventional catalytic processes.

The microwave excitation of the molecules of the carbonaceous material, often referred to as microwave catalysis, excites constituents, such as impurities or contaminants including organics, which have been adsorbed on the internal pore surfaces of the carbonaceous material and produces a highly reactive condition. Further molecules from the carrier medium, such as a sweep gas, are in close proximity or within the surface boundary layer of the carbon surface through chemisorption, absorption, adsorption, or diffusion, and additional chemical reactions with these constituents may occur.

The desorption process potentially produces a wide range of chemical compounds since the microwave excited carbon surface and possibly the sweep gas molecules react with various decomposition products from the adsorbed constituents. Condensation of collected molecules from the sweep gas can be collected if needed.

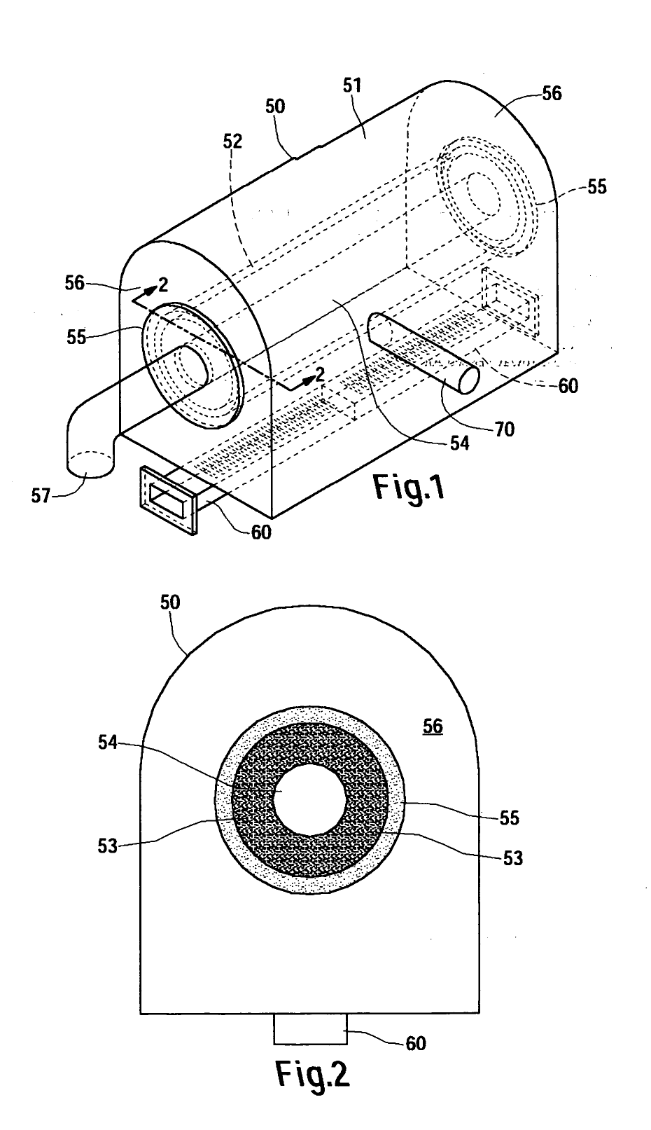

FIG. 1 shows the microwave based air purifier in perspective consisting of ceramic filter element 52 with a hollow space that contains a centered perforated stainless steel tube 54. The space between the perforated tube 54 and the ceramic filter 52 contains a pelletized activated carbon bed 53 that removes impurities from the air stream. The ceramic filter assemble is centered in a microwave cavity 51 at the center-line of a half-cylinder 50 that reflects microwaves toward this center-line. The other part of the cavity 51 contains one or more microwave slot antennas 60 that direct microwaves toward the half-cylinder part of the microwave cavity 51 for redirection toward the centered ceramic filter assembly containing activated carbon 53. Such air enters at the open end of the centered ceramic filter assembly 57, that is attached to the microwave cavity 50 by an end plate 55, through the ceramic filter 52, is purified by the activated carbon bed 53, and leaves the assembly through the perforated tube 54. The microwave cavity 50 contains an outlet 70 for purified air to leave the cavity.

FIG. 2 being the cross-section at 2-2 of FIG. 1 gives a better view of the microwave cavity 50 of the working parts of this microwave based air purifier.

When the activated carbon bed is saturated, as shown by measurements of impurities in the air outlet by a total hydrocarbon analyzer, the inlet air stream is stopped and a vacuum source pulls non-oxygen sweep gas, such as nitrogen, through the system with the microwave slot antennas engaged. When the total hydrocarbon analyzer reads a sufficient small amount of impurity, the activated carbon regeneration is stopped and the regular air purification continued. If the impurity in the air is to be collected, a liquid condenser is utilized with the outlet sweep gas stream.

The scaling of the size of the microwave based air purifier operating with 2450 MHz microwaves depends upon the flow rate desired. The sizes indicated represent a design for processing 115 standard cubic feet per minute of unpurified air. With this amount of air flow, two microwave slot antennas are employed, each putting out one kilowatt, in order to reduce the regeneration cycle to approximately 80 minutes.

### EXAMPLE

To study the stability of activated carbon bed under continuing adsorption and desorption cycles, it was exposed to four such cycles. The example device was a scaled down version employed with 13 standard cubic feet per minute of airflow containing toluene evaporated at 1.3 milliliters per minute. Saturation was run for 120 minutes. For regeneration the microwave energy employed was 1000 watts. The regeneration utilized one standard cubic feet per minute of nitrogen gas and the output concentration of toluene was monitored with a THC analyzer, VIG Industries Model 10. The outlet toluene concentration peaked at near 65000 ppm at about 10 minutes and decreased to near zero at 80 minutes. Measured in terms of carbon bed reactivation efficiency, this obtained over 99% by 80 minutes.

A commercial device for air purification comprising an elongated structural microwave cavity with inlet and exit regions designed to reflect microwaves onto a cavity-centered cylindrical chamber that is designed for gas flow with a fixed bed centered in said chamber composed of carbonaceous material utilizing one or more microwave slot antennas radiating said cavity positioned at a bed external location selected from the group consisting of top, bottom, sides and combinations thereof.

The inlet and exit regions represent connections for gas flow both for purifying the air and regeneration of the carbonaceous material. The bed thickness consists of at least two penetration depths measured with microwaves of 2450 MHz. The frequency employed affects the effective bed thickness since said bed penetration by microwaves is frequency dependent and further depends upon the mass of the bed particles. For 2450 MHz microwaves the penetration thickness—that is, where the intensity of the RF energy has decreased by e⁻¹—of common bed particles is approximately one inch.

The microwave slot antennas, selected from the frequency range of 50 to 5000 MHz, are capable of flexible operation being selected from the group consisting of continuous source, pulsed source, cyclic source, periodic source, and combinations thereof. For a slot antenna to operate effectively the size and spacing of the slots and the size of the antenna are a function of the microwave frequency.

The carbonaceous material is selected from the group consisting of activated carbon, char, soot, pyrolytic carbon, carbon black, activated charcoal, and combinations thereof. The microwave cavity is composed of materials capable of continuous operation at 400° F. The microwave cavity further comprises several metal sections, one of which composes a half-cylinder that reflects microwaves emitted by said slot antennas toward the center-line of said cylindrical cavity which comprises a diameter of 16 inches and a length of 30 inches designed for use with 2450 MHz microwaves radiated from two slot antennas. The device cavity-centered cylindrical elongated chamber contains an outer porous ceramic tube and an inner perforated metal tube, wherein said bed of carbonaceous material occupies the space between said tubes. The ceramic tube is a thickness of 1.5 inches with an outer diameter of 9 inches, and the perforated metal tube is a diameter of 3.5 inches, both designed for use with 2450 MHz microwaves.

A commercial device for air purification comprising an elongated structural microwave cavity with inlet and exit regions operating at 2450 MHz that composes a half-cylinder that reflects microwaves toward the center-line of said cylindrical cavity onto a cavity-centered cylindrical chamber comprising an outer porous ceramic tube and an inner perforated metal tube both designed for gas flow. A fixed bed of carbonaceous material is centered in said chamber that occupies the cylindrical space between the tubes of said chamber, and utilizes one or more microwave slot antennas operating at 2450 MHz radiating said cavity that are positioned at a bed external location selected from the group consisting of top, bottom, sides and combinations thereof.

The inlet and exit regions represent connections for gas flow both for purifyng the air and regeneration of the carbonaceous material. The bed thickness of two inches consists of two penetration depths measured with microwaves of 2450 MHz. The microwave slot antennas are capable of flexible operation being selected from the group consisting of continuous source, pulsed source, cyclic source, periodic source, and combinations thereof. The carbonaceous material is selected from the group consisting of activated carbon, char, soot, pyrolytic carbon, carbon black, activated charcoal, and combinations thereof. The microwave cavity further comprises being composed of materials capable of continuous operation at 400° F.

The half-cylinder comprises a diameter of 16 inches and a length of 30 inches designed for use with 2450 MHz microwaves radiated from two slot antennas. The ceramic tube comprises a thickness of 1.5 inches and an outer diameter of 9 inches, and said perforated metal tube comprises a diameter of 3.5 inches, both designed for use with 2450 MHz microwaves.

The foregoing description of the specific embodiments will so fully reveal the general nature of the invention that others can, by applying current knowledge, readily modify and/or adapt for various applications such specific embodiments without departing from the generic concept, and therefore such adaptations or modifications are intended to be comprehended within the meaning and range of equivalents of the disclosed embodiments. It is to be understood that the phraseology or terminology herein is for the purpose of description and not of limitation.

I claim:

1. A commercial device for air purification comprising:
an elongated structural microwave cavity with inlet and exit regions designed to reflect microwaves onto a cavity-centered cylindrical chamber that is designed for gas flow;
a fixed bed centered in said chamber composed of carbonaceous material; and
one or more microwave slot antennas radiating said cavity positioned at a bed external location selected from the group consisting of top, bottom, sides and combinations thereof.

2. The device according to claim 1 wherein said bed thickness consists of at least two penetration depths measured with microwaves of 2450 MHz.

3. The device according to claim 1 wherein said microwave slot antennas, selected from the frequency range of 50 to 5000 MHz, are capable of flexible operation being selected from the group consisting of continuous source, pulsed source, cyclic source, periodic source, static frequency, dynamic frequency, and combinations thereof.

4. The device according to claim 1 wherein said carbonaceous material further comprises being selected from the group consisting of activated carbon, char, soot, pyrolytic carbon, carbon black, activated charcoal, and combinations thereof.

5. The device according to claim 1 wherein said microwave cavity further comprises being composed of materials capable of continuous operation at 400° F.

6. The device according to claim 1 wherein said microwave cavity further comprises several metal sections, one of which composes a half-cylinder that reflects microwaves emitted by said slot antennas toward the center-line of said cylindrical cavity.

7. The device according to claim 6 wherein said half-cylinder comprises a diameter of 16 inches and a length of 30 inches designed for use with 2450 MHz microwaves radiated from two slot antennas.

8. The device according to claim 1 wherein said cavity-centered cylindrical elongated chamber further comprises an outer porous ceramic tube and an inner perforated metal tube, wherein said bed of carbonaceous material occupies the space between said tubes.

9. The device according to claim 8 wherein said ceramic tube further comprises a thickness of 1.5 inches and an outer diameter of 9 inches, and said perforated metal tube further comprises a diameter of 3.5 inches, both designed for use with 2450 MHz microwaves.

10. A commercial device for air purification comprising:
an elongated structural microwave cavity with inlet and exit regions operating at 2450 MHz that comprises a half-cylinder that reflects microwaves toward the center-line of said cylindrical cavity onto a cavity-centered cylindrical chamber comprising an outer porous ceramic tube and an inner perforated metal tube both designed for gas flow;
a fixed bed of carbonaceous material centered in said chamber that occupies the cylindrical space between the tubes of said chamber; and
one or more microwave slot antennas operating at 2450 MHz radiating said cavity positioned at a bed external location selected from the group consisting of top, bottom, sides and combinations thereof.

11. The device according to claim 10 wherein said bed thickness consists of at least two penetration depths measured with microwaves of 2450 MHz.

12. The device according to claim 10 wherein said microwave slot antennas are capable of flexible operation being selected from the group consisting of continuous source, pulsed source, cyclic source, periodic source, and combinations thereof.

13. The device according to claim 10 wherein said carbonaceous material further comprises being selected from the group consisting of activated carbon, char, soot, pyrolytic carbon, carbon black, activated charcoal, and combinations thereof.

14. The device according to claim 10 wherein said microwave cavity further comprises being composed of materials capable of continuous operation at 400° F.

15. The device according to claim 10 wherein said half-cylinder comprises a diameter of 16 inches and a length of 30 inches designed for use with 2450 MHz microwaves radiated from two slot antennas.

16. The device according to claim 10 wherein said ceramic tube further comprises a thickness of 1.5 inches and an outer diameter of 9 inches, and said perforated metal tube further comprises a diameter of 3.5 inches, both designed for use with 2450 MHz microwaves.
